(19) United States
(12) Patent Application Publication
(10) Pub. No.: US 2023/0221462 A1
(43) Pub. Date: Jul. 13, 2023

(54) METASURFACE OPTICAL DEVICE WITH TILTED NANO-STRUCTURE UNITS AND OPTICAL APPARATUS

(71) Applicant: Shphotonics Ltd, Suzhou (CN)

(72) Inventors: Lei SUN, Suzhou (CN); Bing QIU, Suzhou (CN)

(21) Appl. No.: 18/153,506

(22) Filed: Jan. 12, 2023

(30) Foreign Application Priority Data
Jan. 13, 2022 (CN) 202220088595.0

(51) Int. Cl. G02B 1/00; G02B 5/18

(52) U.S. Cl. CPC G02B 1/002; G02B 5/1861

(57) ABSTRACT

A metasurface optical device includes a substrate and a nano-structure layer disposed on the substrate. The nano-structure layer includes a plurality of nano-structure units. The plurality of nano-structure units extend in a direction away from the substrate, and central axes of the plurality of nano-structure units form corresponding angles with respect to a normal direction of the substrate, such that the plurality of nano-structure units are arranged obliquely relative to the substrate.

### CROSS-REFERENCE TO RELATED APPLICATION

This application claims priority to Chinese Patent Application No. 202220088595.0, filed on Jan. 13, 2022, the entire content of which is incorporated herein by reference.

### TECHNICAL FIELD

The present disclosure relates to the technical field of metasurface technologies and, in particular, to metasurface optical device with tilted nano-structure units and optical apparatus.

### BACKGROUND

Metasurface refers to an artificial two-dimensional material with the sizes of basic structure units smaller than the working wavelengths and in the order of nanometers in the near-infrared and visible band. Metasurface can realize flexible and effective control of the characteristics, such as polarization, amplitude, phase, propagation direction and mode, etc., of electromagnetic waves.

Metasurface is ultra-light, ultra-thin and multifunctional optical device. Compared with conventional optical devices, a metasurface optical device manufactured based on semiconductor technology has the advantages of excellent optical performance, small size, and high integration. Metasurface optical devices can be widely used in future portable and miniaturized devices, such as augmented reality wearable devices, virtual reality wearable devices, and mobile terminal lenses.

### SUMMARY

One aspect of the present disclosure provides a metasurface optical device. The metasurface optical device includes a substrate and a nano-structure layer disposed on the substrate. The nano-structure layer includes a plurality of nano-structure units. The plurality of nano-structure units extend in a direction away from the substrate, and central axes of the plurality of nano-structure units form corresponding angles with respect to a normal direction of the substrate, such that the plurality of nano-structure units are arranged obliquely relative to the substrate.

Another aspect of the present disclosure provides an optical apparatus. The optical apparatus includes a metasurface optical device. The metasurface optical device includes a substrate and a nano-structure layer disposed on the substrate. The nano-structure layer includes a plurality of nano-structure units. The plurality of nano-structure units extend in a direction away from the substrate, and central axes of the plurality of nano-structure units form corresponding angles with respect to a normal direction of the substrate, such that the plurality of nano-structure units are arranged obliquely relative to the substrate.

### BRIEF DESCRIPTION OF THE DRAWINGS

FIG. 1 is a schematic diagram showing operation principle of an exemplary metasurface optical device.

FIG. 2 is a schematic diagram showing operation principle of an exemplary tilted grating.

FIG. 3 is a schematic structural diagram of an exemplary metasurface optical device according to some embodiments of the present disclosure.

FIG. 4 is a cross-sectional view in A-A direction in FIG. 3.

FIG. 5 is a schematic structural diagram of an exemplary metasurface optical device according to some embodiments of the present disclosure.

FIG. 6 is a schematic structural diagram of an exemplary metasurface optical device according to some embodiments of the present disclosure.

FIG. 7 is a schematic structural diagram of an exemplary metasurface optical device according to some embodiments of the present disclosure.

FIG. 8 is a schematic structural diagram of an exemplary optical apparatus according to some embodiments of the present disclosure.

### DETAILED DESCRIPTION OF THE EMBODIMENTS

In the following, some example embodiments are described. As those skilled in the art would recognize, the described embodiments can be modified in various different manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of manufacturing techniques and/or tolerances, can be expected. Thus, embodiments of the present disclosure should not be interpreted as being limited to the specific shapes of regions illustrated in the drawings, but are to include deviations in shapes that result, for example, from manufacturing. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

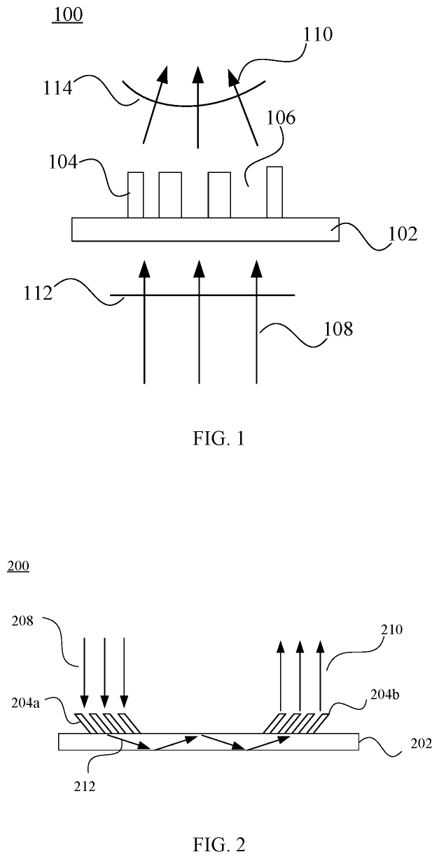

FIG. 1 is a schematic diagram showing operation principle of an exemplary metasurface optical device 100.

As shown in FIG. 1, the metasurface optical device 100 includes a substrate 102, a plurality of nano-structure units (such as nanopillars) 104 arranged on the substrate 102, and a dielectric protection material 106 protecting the plurality of nano-structure units 104. The plurality of nano-structure units 104 have a sub-wavelength size, and hence can modulate light of a corresponding operation wavelength locally. Also, the plurality of nano-structure units 104 may have different sizes, shapes, and arrangement periodicities on the substrate 102. Thus, when the light passes through the metasurface optical device 100, the array of nano-structure units 104 flexibly and effectively regulates properties of the light such as polarization, amplitude, phase, polarization mode, propagation direction, and propagation mode. The dielectric protection material 106 is arranged to surround the plurality of nano-structure units 104 for protection and support. A refractive index of a material of the plurality of nano-structure units 104 is greater than a refractive index of the dielectric protection material 106, such that most of the light passing through the plurality of nano-structure units 104 propagates therein.

The operation principle of the metasurface optical device 100 is as follows. When an incident light 108 enters the metasurface optical device, part of the light enters the plurality of nano-structure units 104 through the substrate 102, and another part of the light enters the dielectric protection material 106 through the substrate 102. Since the refractive index of the material of the plurality of nano-structure units 104 is greater than the refractive index of the dielectric protection material 106, the light entering the plurality of nano-structure units 104 mainly propagates inside the plurality of nano-structure units 104, and is modulated locally by different effective refractive indices. The light not entering the plurality of nano-structure units 104 passes directly through the dielectric protection material 106. In this way, the metasurface optical device 100 locally modulates the incident light 108 through the plurality of nano-structure units 104 with different effective refractive indices, and changes the properties, such as polarization, amplitude, phase, polarization mode, propagation direction, and propagation mode, of the incident light 108. As shown in FIG. 1, the incident light 108 originally having a planar wavefront 112 becomes an outgoing light 110 having a curved wavefront 114 after passing through the metasurface optical device 100, thereby realizing modulation of the wavefront of light.

FIG. 2 is a schematic diagram showing operation principle of an exemplary tilted grating.

As shown in FIG. 2, the optical device 200 includes an optical waveguide 202, a tilted grating 204a arranged on a left side of a surface of the optical waveguide 202, and a tilted grating 204b arranged on a right side of the surface of the optical waveguide 202. Vertically incident light 208 changes its propagation direction after passing through the tilted grating 204a and is coupled into the optical waveguide 202. The light 212 coupled into the optical waveguide 202 is totally reflected in the optical waveguide 202, and propagates in the optical waveguide 202. When the light 212 propagating in the optical waveguide 202 reaches a position of the tilted grating 204b, the light 212 changes the propagation direction and is coupled out of the optical waveguide 202 to obtain the outgoing light 210 emitted vertically. As above described, the tilted gratings 204a and 204b arranged in the optical device 200 deflect the light, and thus can be used to change the propagation direction of the light.

However, some metasurface optical devices may have low transmission efficiency and low reflection efficiency, resulting in a substantial energy loss of the incident light. Further, some tilted gratings may perform only a single function, i.e., changing the propagation direction of the incident light.

The present disclosure provides a metasurface optical device and an optical apparatus including the metasurface optical device. In the metasurface optical device, a central axis of each of a plurality of nanostructure units on the substrate forms a certain angle with respect to a normal direction of the substrate, such that the plurality of nano-structure units are arranged obliquely relative to the substrate. Since the metasurface optical device consistent with the disclosure combines the advantages of versatile functions of metasurface optical devices and high transmission efficiency of tilted gratings, the metasurface optical device consistent with the disclosure can flexibly and effectively control and adjust the properties, such as phase, amplitude, polarization mode, propagation direction, and propagation mode, of the incident light, and at the same time, can improve the transmission efficiency or the reflection efficiency of the incident light.

In some embodiments, the metasurface optical device includes a substrate and a nano-structure layer on the substrate. The nano-structure layer includes a plurality of nano-structure units. The plurality of nano-structure units extend in a direction away from the substrate, and the central axes of the plurality of nano-structure units form corresponding angles with respect to the normal direction of the substrate, such that the plurality of nano-structure units are arranged obliquely relative to the substrate.

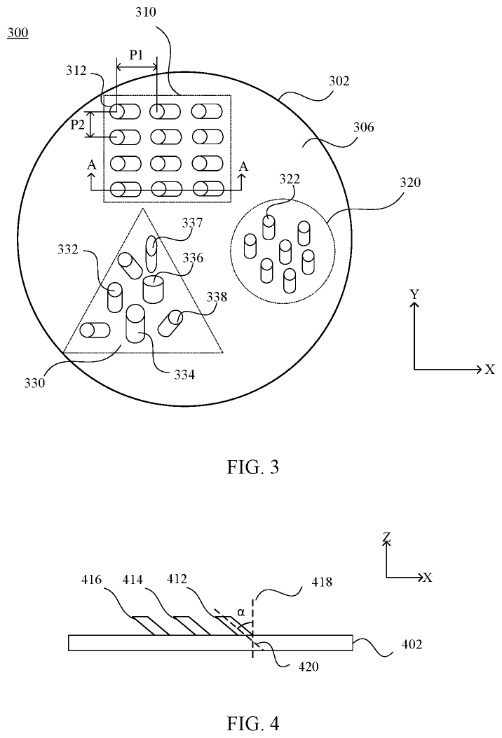

FIG. 3 is a top view of an exemplary metasurface optical device 300 according to some embodiments of the present disclosure.

As shown in FIG. 3, the metasurface optical device 300 includes a substrate 302 and a nano-structure layer on the substrate (the portions in the rectangular dotted line frame, the circular dotted line frame, and the triangle dotted line frame). The nano-structure layer includes a plurality of nano-structure units (such as nano-structure units 312, 322, 332, etc.), which are nano-structures protruding from the substrate 302 and extending in a direction away from the substrate. The central axes of the plurality of nano-structure units (the line connecting the geometric centers of the cross-sections in the height direction) each form a certain angle with respect to the normal direction of the substrate, such that the plurality of nano-structure units are arranged obliquely relative to the substrate. That is, the plurality of nano-structure units are not arranged vertically to the substrate. A dielectric protection material 306 overlying the substrate 302 is arranged to surround the plurality of nano-structure units for protection and support.

In some embodiments, types of material of the substrate are not limited. For example, the substrate may include any one of glass, quartz, polymer, germanium, and plastic. Types of material of the nano-structure layer are not limited. For example, the nano-structure layer may include at least one of single crystal silicon, polycrystalline silicon, amorphous silicon, silicon carbide, titanium dioxide, silicon nitride, germanium, hafnium dioxide, or group III-V compounds. Among them, the group III-V compounds are compounds formed by boron, aluminum, gallium, or indium of group III, and nitrogen, phosphorus, arsenic, or antimony of group V in the periodic table of elements, such as gallium phosphide, gallium nitride, gallium arsenide, indium phosphide, etc.

In embodiments of the disclosure, a shape of the substrate is not limited. For example, the shape of the substrate may be a regular shape such as a circle, a square, a rectangle, a polygon, or the like. In some other examples, the shape of the substrate may be irregular. The shape of the substrate can be designed based on specific applications of the metasurface optical device.

In some embodiments, the obliquely arranged plurality of nano-structure units may be arranged in a regular manner on the substrate, such as an array arrangement, a circular arrangement, a triangular arrangement, a hexagonal arrangement, and the like. In some other embodiments, the obliquely arranged plurality of nano-structure units may be arranged in an irregular manner on the substrate, such as randomly arranged.

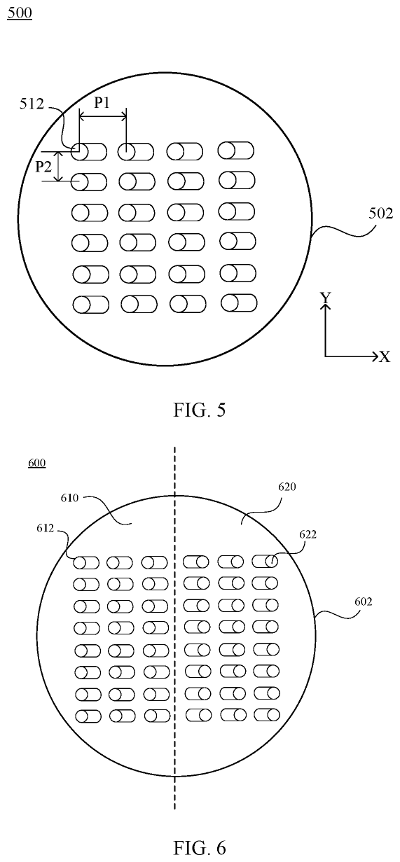

In some embodiments, the obliquely arranged plurality of nano-structure units may be arranged at a constant period on the substrate. As shown in FIG. 5, in the metasurface optical device 500, an arrangement period of the plurality of nano-structure units 512 on the substrate 502 may be understood as a distance between respective geometric centers of adjacent nano-structure units. The plurality of nano-structure units 512 being arranged with the constant period can be as shown in FIG. 5. The plurality of nano-structure units 512 may be arranged with a constant period P1 in an X direction in the top view plane of the substrate 502, and a constant period P2 in a Y direction in the top view plane of the substrate 502. In some other embodiments, the plurality of nano-structure units 512 may be periodically arranged in other arrangements on the substrate 502, and these arrangements include but are not limited to circular arrangements, triangular arrangements, hexagonal arrangements, etc.

In some embodiments, the obliquely arranged plurality of nano-structure units may be arranged at non-constant periods on the substrate. Referring to FIG. 5, when the plurality of nano-structure units 512 are arranged in an array on the substrate 502, the plurality of nano-structure units 512 may have a varying period P1 in the X direction in the top view plane of the substrate 502, and a varying period P2 in the Y direction in the top view plane of the substrate 502. In some other embodiments, the plurality of nano-structure units 512 may be arranged non-periodically on the substrate 502 in another manner. These arrangements include but are not limited to circular arrangement, triangular arrangement, hexagonal arrangement, etc.

In some embodiments, the nano-structure layer includes a plurality of functional regions. Each functional region includes a corresponding subset of the plurality of nano-structure units. The plurality of nano-structure units are arranged such that the plurality of functional regions have different optical functions.

Referring again to FIG. 3, the nano-structure layer of the metasurface optical device 300 includes a first functional region 310, a second functional region 320, and a third functional region 330. Different types of nano-structure units are respectively arranged in the first functional region 310, the second functional region 320, and the third functional region 330. In some embodiments, the plurality of nano-structure units 312 in the first functional region 310 are all tilted to the negative direction of the X axis. Orthogonal projections of the plurality of nano-structure units 312 on the substrate 302 have a same shape and a same dimension. Orthogonal projections of the plurality of nano-structure units 312 on a direction perpendicular to the substrate 302 also have a same shape and a same dimension. In addition, the plurality of nano-structure units 312 are arranged at a constant period, that is, the period P1 in the X axis direction remains unchanged and the period P2 in the Y axis direction remains unchanged. In some embodiments, the plurality of nanostructure units 322 in the second functional region 320 are all tilted to the positive direction of the Y axis. Orthogonal projections of the plurality of nano-structure units 322 on the substrate 302 have a same shape and a same dimension. Orthogonal projections of the plurality of nano-structure units 322 on a direction perpendicular to the substrate 302 also have a same shape and a same dimension. However, the plurality of nano-structure units 322 are arranged at a non-constant period. In some embodiments, the plurality of nano-structure units (nano-structure units 332, etc.) in the third functional region 330 are tilted in various directions in the XY plane. In addition, the plurality of nano-structure units are designed such that the shapes of the orthogonal projections of the plurality of nano-structure units on the substrate 302 are not completely same, the dimensions of the orthogonal projections of the plurality of nano-structure units on the substrate 302 are not completely same, the dimensions of the orthogonal projections of the plurality of nano-structure units on the direction perpendicular to the substrate 302 are not completely same, and the plurality of nano-structure units are not arranged at a constant period. When the nano-structure layer is arranged in the above manner, the incident light entering different regions may have different exit angles, polarizations, wavelengths, lens focal lengths, and other characteristics after exiting.

In the specification, phrases like “parameters B of a plurality of A's are not identical” mean that the plurality of A's are intentionally designed such that the parameters B of the plurality of A's formed by the manufacturing process are not all the same. Thus, these parameters B that are not all the same should not be interpreted as the result of errors in the manufacturing process, and vice versa. For example, “the dimensions of the plurality of nano-structure units in the direction perpendicular to the substrate are not completely same” means that the plurality of nano-structure units are designed in a way that their vertical dimensions are not all the same, and the difference in the vertical dimensions is not due to manufacturing process errors or measurement errors.

In some embodiments, different functional regions are different in at least one of the following aspects: angles between the central axes of the plurality of nano-structure units and the normal direction of the substrate; shapes of the orthogonal projections of the plurality of nano-structure units on the substrate; dimensions of the orthogonal projections of the plurality of nano-structure units on the substrate; dimensions of the orthogonal projections of the plurality of nano-structure units on the direction perpendicular to the substrate; arrangement periodicities of the plurality of nano-structure units on the substrate; arrangement patterns of the plurality of nano-structure units on the substrate; the orientations of the orthogonal projections of the plurality of nano-structure units on the substrate; or materials of the plurality of nano-structure units. Different functions in different regions may be configured flexibly and conveniently by adjusting the above parameters.

Structures and characteristics of nano-structure units in different functional regions will be further described below with reference to FIG. 3 and FIG. 4.

In some embodiments, angles of the central axes of the nano-structure units in different functional regions relative to the normal direction of the substrate are different, that is, tilt angles of the nano-structure units are different. A tilt angle of a nano-structure unit is described with reference to FIG. 4. As shown in FIG. 4, the tilt angle of the nano-structure unit can be understood as an angle value a between the central axis 420 of the nano-structure unit 412 and the normal direction 418 of the substrate 402, and the tilt direction of the nano-structure unit. Only when the angle values a of the plurality of nanostructure units have a same numerical magnitude and the plurality of nano-structure units have a same tilt direction, the plurality of nano-structure units can be considered to have the same tilt angle. As shown in FIG. 4, since the nano-structure unit 416, the nano-structure unit 414, and the nano-structure unit 412 are all tilted to the negative direction of the X axis and the tilt angles have the same numerical value, the nano-structure unit 416, the nano-structure unit 414, and the nano-structure unit 412 are considered to have the same tilt angle. That is, the nano-structure units in different functional regions having different tilt angles may include: the nano-structure units in different functional regions having different numerical values of the tilt angles, and/or the nano-structure units in different functional regions having different tilt directions.

In some embodiments, the orthogonal projections of the plurality of nano-structure units in different functional regions on the substrate may have different shapes. Referring back to FIG. 3, the orthogonal projection of the nano-structure unit 312 in the first functional region 310 on the substrate 302 has a circular shape, while the orthogonal projection of the nano-structure unit 336 in the third functional region 330 on the substrate 302 has an oval shape. In some other embodiments, the orthogonal projections of the nano-structure units in different functional regions on the substrate may have an ellipse shape, a rectangle shape, a hexagon shape, a triangle shape, and a sector shape, etc., and may have a symmetrical shape or an asymmetrical shape.

In some embodiments, the orthogonal projections of the plurality of nano-structure units in different functional regions on the substrate may have different dimensions. As shown in FIG. 3, the orthogonal projection of the nano-structure unit 312 in the first functional region 310 on the substrate 302 and the orthogonal projection of the nano-structure unit 322 in the second functional region 320 on the substrate 302 are circles with different radii. In some other embodiments, the orthogonal projections of plurality of nano-structure units in different functional regions on the substrate may have triangle shapes with different side lengths, rectangular shapes, hexagonal shapes, and ellipse shapes with different semi-major axes and semi-minor axes.

In some embodiments, the plurality of nano-structure units in different functional regions may have different dimensions in the direction perpendicular to the substrate. As shown in FIG. 3, in the direction perpendicular to the substrate 302, the dimension of the nano-structure unit 322 in the second functional region 320 is different from the dimension of the nano-structure unit 334 in the third functional region 330, that is, the height of the nano-structure unit 322 is different from the height of nano-structure unit 334.

In some embodiments, the plurality of nano-structure units in different functional regions on the substrate may have different periodicities. In one example, the plurality of nano-structure units in one region may be arranged periodically on the substrate, while the plurality of nano-structure units in the other region may not be arranged periodically on the substrate, such as the plurality of nano-structure units in the first functional region 310 and the second functional region 320 in FIG. 3. In another example, the plurality of nano-structure units in two functional regions both may be arranged periodically, but may have different arrangement periods.

In some embodiments, the plurality of nano-structure units in different functional regions on the substrate may have different arrangement patterns. For example, the arrangement pattern of the plurality of nano-structure units in one functional region may be one of a rectangular pattern, a triangular pattern, a rhombus pattern, a hexagonal pattern, and a random arrangement pattern, etc., and the arrangement pattern of the plurality of nano-structure units in another functional region may be another one of a rectangular pattern, a triangular pattern, a rhombus pattern, a hexagonal pattern, and a random arrangement pattern, etc.

In some embodiments, the orthogonal projections of the plurality of nano-structure units on the substrate in different functional regions may have different orientations. For example, the orthogonal projections of the plurality of nano-structure units in one functional region on the substrate may be at an angle relative to a certain reference direction, and the orthogonal projection of the plurality of nano-structure units in another functional region on the substrate may be at another angle relative to the above reference direction.

In some embodiments, the plurality of nano-structure units in different functional regions may be made of different materials. For example, the plurality of nano-structure units in one functional region may be made of one of single crystal silicon, polycrystalline silicon, amorphous silicon, silicon carbide, titanium dioxide, silicon nitride, germanium, hafnium dioxide, and group III-V compounds, etc., while the plurality of nano-structure units in another functional region may be made of another one of single crystal silicon, polycrystalline silicon, amorphous silicon, silicon carbide, titanium dioxide, silicon nitride, germanium, hafnium dioxide, and group III-V compounds, etc.

The following describes how different functional regions are configured with reference to FIG. 6. In some embodiments, as shown in FIG. 6, the metasurface optical device 600 includes a substrate 602, and a functional region 610 and a functional region 620 arranged on the substrate 602. A plurality of nano-structure units 612 in the functional region 610 and a plurality of nano-structure units 622 in the functional region 620 have different tilt angles. In some other embodiments, the plurality of nano-structure units 612 and the plurality of nano-structure units 622 may also be different in at least one of the following: shapes of the orthogonal projections on the substrate 602, dimensions of the orthogonal projections on the substrate 602, dimensions of the orthogonal projections on the direction perpendicular to the substrate 602, arrangement periodicities on the substrate 602, arrangement patterns on the substrate 602, orientations of the orthogonal projections on the substrate 602, or materials of the plurality of nano-structure units. Thus, the functional region 610 and the functional region 620 may have different functions. For example, when a beam of incident light passes through two functional regions of the metasurface optical device 600, two beams of outgoing light with different outgoing directions can be obtained. In some other embodiments, the different functions of the functional regions may also include making the outgoing light passing through the different functional regions have different properties such as different polarizations, wavelengths, and/or lens focal lengths.

In some embodiments, for at least one functional region among a plurality of functional regions, the at least one functional region satisfies at least one of the following: angles of the central axes of the plurality of nano-structure units in the at least one functional region relative to the normal direction of the substrate are not completely same; shapes of the orthogonal projections of the plurality of nano-structure units in the at least one functional region on the substrate are not completely same; dimensions of the orthogonal projections of the plurality of nano-structure units in the at least one functional region on the substrate are not completely same; dimensions of the orthogonal projections of the plurality of nano-structure units in the at least one functional region on the direction perpendicular to the substrate are not completely same; arrangement periodicities of the plurality of nano-structure units in the at least one functional region on the substrate are not completely same; arrangement patterns of different subsets of the plurality of nano-structure units in the at least one functional region on the substrate are not completely same; orientations of the orthogonal projections of the plurality of nano-structure units in the at least one functional region on the substrate are not completely same; or materials of the plurality of nano-structure units in the at least one functional region are not completely same. By adjusting the above parameters, the function of the at least one functional region can be configured flexibly and conveniently.

In some embodiments, the angles of the central axes of the plurality of nano-structure units in one functional region relative to the normal direction of the substrate are not completely same, that is, the tilt angles of the plurality of nano-structure units are not completely same. Referring again to the third functional region 330 in FIG. 3, in some embodiments, the numerical values of the tilt angles of the plurality of nano-structure units are the same, but the tilt directions of the plurality of nano-structure units are different, such as the nano-structure unit 332 and the nano-structure unit 338. In some other embodiments, the tilt directions of the plurality of nano-structure units are the same, but the numerical values of the tilt angles of the plurality of nano-structure units are different. For example, the numerical value of the tilt angle of the nano-structure unit 412 in FIG. 4 is α, while the numerical value of the tilt angle of the nano-structure unit 414 is another value different from α.

In some embodiments, the shapes of the orthogonal projections of the plurality of nano-structure units in a same functional region on the substrate may not be completely the same. Referring to the third functional region 330 in FIG. 3, in the direction of the orthogonal projection of the substrate 302, the orthogonal projection of the nano-structure unit 332 is a circle, and the orthogonal projection of the nano-structure unit 336 is an ellipse. In some other embodiments, the shapes of the orthogonal projections of the plurality of nano-structure units in one functional region on the substrate 302 may be two or more of an ellipse, a rectangle, a hexagon, a triangle, a sector, etc., and may be a symmetrical shape or an asymmetrical shape.

In some embodiments, the dimensions of the orthogonal projections of the plurality of nano-structure units on the substrate in a same functional region may not be completely the same. Referring to the third functional region 330 in FIG. 3, the orthogonal projection of the nano-structure unit 332 on the substrate 302 and the orthogonal projection of the nano-structure unit 334 on the substrate 302 are circles with different radii. In some other embodiments, the orthogonal projections of the plurality of nano-structure units in one functional region on the substrate 302 may be triangular shapes with different sides, rectangular shapes with different sides, hexagonal shapes with different sides, and elliptical shapes with different semi-major axes and different semi-minor axes, etc.

In some embodiments, the dimensions of the plurality of nano-structure units in a same functional region in the direction perpendicular to the substrate may not be completely the same. Referring to the third functional region 330 in FIG. 3, in the direction perpendicular to the substrate 302, the dimension of the nano-structure unit 332 is different from the dimension of the nano-structure unit 334, that is, the height of the nano-structure unit 332 is different from the height of the nano-structure unit 334.

In some embodiments, the arrangement periodicities of the plurality of nano-structure units in a same functional region on the substrate may be different. Referring to the third functional region 330 in FIG. 3, the plurality of nano-structure units in the third functional region 330 are arranged at a non-constant arrangement period.

In some embodiments, the arrangement patterns of different subsets of the plurality of nano-structure units in a same functional region on the substrate may not be completely the same. For example, the arrangement pattern of one subset of the plurality of nano-structure units in one functional region may be one of a rectangular pattern, a triangular pattern, a rhombus pattern, a hexagonal pattern, and a random arrangement pattern, etc., and the arrangement pattern of another subset of the plurality of nano-structure units in the functional region may be another one of the rectangular pattern, the triangular pattern, the rhombus pattern, the hexagonal pattern, and the random arrangement pattern, etc.

In some embodiments, the orientations of the orthogonal projections of the plurality of nano-structure units in a same functional region on the substrate may not be completely the same. For example, the orthogonal projection of a subset of the plurality of nano-structure units in one functional region on the substrate may be at an angle relative to a certain reference direction, and the orthogonal projection of another subset of the plurality of nano-structure units in the functional region on the substrate may be at another angle relative to the above reference direction. Referring to the nano-structure unit 336 and the nano-structure unit 337 in the third functional region 330 in FIG. 3, the difference between the two is that an angle between the semi-major axis of the orthogonal projection of the nano-structure unit 336 on the substrate and the positive direction of the X axis (reference direction) is about 0 degree, and an angle between the semi-major axis of the orthogonal projection of the nano-structure unit 337 on the substrate and the positive direction of the X axis (reference direction) is about 90 degrees.

In some embodiments, the materials of the plurality of nano-structure units in a same functional region may not be completely the same. For example, the material of a subset of the plurality of nano-structure units in one functional region on the substrate may be one of monocrystalline silicon, polycrystalline silicon, amorphous silicon, silicon carbide, titanium dioxide, silicon nitride, germanium, hafnium dioxide, and group III-V compounds, etc. The material of another subset of the plurality of nano-structure units in the functional region may be another of monocrystalline silicon, polycrystalline silicon, amorphous silicon, silicon carbide, titanium dioxide, silicon nitride, germanium, hafnium dioxide, and group III-V compounds, etc.

In some embodiments, the shapes of the plurality of functional regions may not be completely the same, and/or the areas of the plurality of functional regions may not be completely the same. Referring to the first functional region 310, the second functional region 320, and the third functional region 330 in FIG. 3, the shapes and/or areas of the plurality of functional regions may be designed based on specific applications of the metasurface optical device.

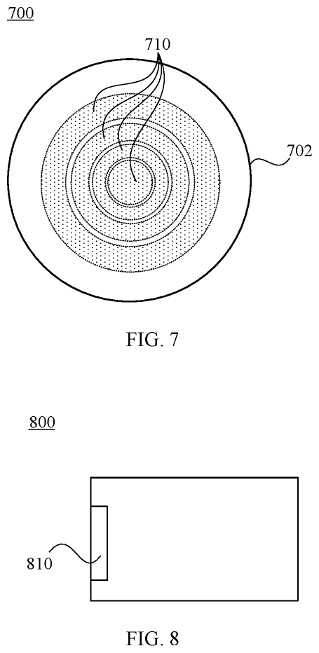

In some embodiments, the plurality of functional regions are arranged in an array on the substrate, including but not limited to a rectangular array, a triangular array, a hexagonal array, and the like. In some other embodiments, the plurality of functional regions are sequentially arranged on the substrate along a circumferential direction of a circle. As shown in FIG. 7, in the metasurface optical device 700, a plurality of functional regions 710 on the substrate 702 are nested and arranged sequentially along a radial direction of a circle, and the plurality of functional regions 710 may have different widths in the radial direction of the circle. The arrangement of the plurality of functional regions may be designed based on the specific applications of the metasurface optical device.

In some embodiments, the plurality of nano-structure units may be nanopillars, i.e., columnar structures protruding from the substrate. In some other embodiments, the plurality of nano-structure units in a plurality of photonic crystal units may also be nanoholes, that is, a plurality of hole structures formed in a dielectric protection material. The plurality of hole structures may be filled with, for example, air.

In some embodiments, a surface of the substrate facing away from the nano-structure layer and/or a surface of the substrate facing toward the nano-structure layer may be covered with a reflective layer. In some embodiments, the reflective layer may completely cover one side of the substrate where the nano-structure units are arranged, and may be disposed between the plurality of nano-structure units and the substrate. In some other embodiments, the reflective layer may completely cover the other side of the substrate, that is, completely cover the side of the substrate where no nano-structure unit is arranged.

In the present disclosure, a type of the reflective layer is not limited. In some embodiments, the reflective layer may be one of a metal reflective layer, a dielectric reflective layer, and a metal-dielectric reflective layer with relatively high reflectivity. For example, the reflective layer is the metal reflective layer, and the material of the metal reflective layer may be a metal material with a large extinction coefficient, a high reflectivity, and stable optical properties, such as gold, silver, copper, chromium, platinum, aluminum, etc. In another example, the reflective layer is the dielectric reflective layer, and the material of the dielectric reflective layer is not limited. The reflective layer may include at least one of monocrystalline silicon, polycrystalline silicon, amorphous silicon, silicon carbide, titanium dioxide, silicon nitride, germanium, hafnium dioxide, or group III-V compounds. Among them, the group III-V compounds are compounds formed by one or more of boron, aluminum, gallium, and indium of group III in the periodic table of elements, and one or more of nitrogen, phosphorus, arsenic, and antimony of group V in the periodic table of elements, such as gallium phosphide, gallium nitride, gallium arsenide, indium phosphide, etc. In another example, the reflective layer is the metal-dielectric reflective layer, that is, a dielectric layer is covered on the metal reflective layer for protection. The material of the dielectric protective layer may be a dielectric material such as silicon monoxide, magnesium fluoride, silicon dioxide, and aluminum oxide. By adding the reflective layer with high reflectivity, the metasurface optical device of the present disclosure can be used as a reflective component, reflecting back locally modulated light by the plurality of nano-structure units instead of letting the locally modulated light pass through the metasurface optical device.

In some other embodiments, the reflective layer may be a grating or a dielectric material layer. In this scenario, when a light enters the metasurface optical device in the present disclosure, the light is neither completely transmitted nor fully reflected. Rather, a portion of the light is transmitted through the metasurface optical device, and another portion of the light is reflected back. A ratio of transmitted portion of the light over the reflected portion of the light may be adjusted according to actual usage requirements. In one example, 80% of the light may be transmitted and 20% of the light may be reflected. In another example, 20% of the light may be transmitted and 80% of the light may be reflected. In another example, 50% of the light may be transmitted and 50% of the light may be reflected. When the reflective layer is a grating (the grating is surrounded by a dielectric material to flatten surfaces of the grating, and the reflective layer includes a multilayer grating), a refractive index of the grating, a refractive index of the material between adjacent layers of the grating, and a thickness of each layer of the grating, etc. may be changed to adjust the ratio of the transmitted portion of the light over the reflected portion of the light. When the reflective layer is a dielectric material layer, the ratio of the transmitted portion of the light over the reflected portion of the light may be adjusted by changing the material refractive index difference between the dielectric material layer and the substrate.

The present disclosure also provides an optical apparatus. As shown in FIG. 8, the optical apparatus 800 includes a metasurface optical device 810. The metasurface optical device 810 may be any of the metasurface optical devices previously described in the embodiments of the present disclosure. Specific product type of the optical apparatus 800 is not limited. For example, the optical apparatus 800 may be a lens of an augmented reality wearable device, a virtual reality wearable device, a mobile terminal, etc., or a spectrometer, a microscope, a telescope, or the like. Due to the improved optical performance of the metasurface optical device 810, the optical apparatus 800 also has a desired optical performance.

The specification provides many different embodiments or examples that can be used to implement the present disclosure. It should be understood that these different embodiments or examples are merely exemplary and are not intended to limit the scope of the present disclosure in any way. Those skilled in the art can conceive of various changes or substitutions based on the description in the specification of the present disclosure, and these should be covered within the scope of the present disclosure. Therefore, the scope of the present disclosure should be defined by the appended claims.

What is claimed is:

1. A metasurface optical device comprising:
a substrate; and
a nano-structure layer disposed on the substrate, the nano-structure layer including a plurality of nano-structure units;
wherein the plurality of nano-structure units extend in a direction away from the substrate, and central axes of the plurality of nano-structure units form corresponding angles with respect to a normal direction of the substrate, such that the plurality of nano-structure units are arranged obliquely relative to the substrate.

2. The metasurface optical device according to claim 1, wherein:
the nano-structure layer includes a plurality of functional regions;
each of the plurality of functional regions includes a corresponding subset of the plurality of nano-structure units; and
the plurality of nano-structure units are arranged in a manner that the plurality of functional regions have different optical functions.

3. The metasurface optical device according to claim 2, wherein different ones of the plurality of functional regions are different in at least one of following aspects:
the angles between the central axes of the plurality of nano-structure units and the normal direction of the substrate;
shapes of orthogonal projections of the plurality of nano-structure units on the substrate;
dimensions of the orthogonal projections of the plurality of nano-structure units on the substrate;
dimensions of orthogonal projections of the plurality of nano-structure units on a direction perpendicular to the substrate;
arrangement periodicities of the plurality of nano-structure units on the substrate;
arrangement patterns of the plurality of nano-structure units on the substrate;
orientations of the orthogonal projections of the plurality of nano-structure units on the substrate; and
materials of the plurality of nano-structure units.

4. The metasurface optical device according to claim 2, wherein one functional region among the plurality of functional regions satisfies at least one of:
the angles of the central axes of the nano-structure units in the subset in the one functional region relative to the normal direction of the substrate are not completely same;
shapes of orthogonal projections of the nano-structure units in the subset in the one functional region on the substrate are not completely same;
dimensions of the orthogonal projections of the nano-structure units in the subset in the one functional region on the substrate are not completely same;
dimensions of orthogonal projections of the nano-structure units in the subset in the one functional region on a direction perpendicular to the substrate are not completely same;
arrangement periodicities of the nano-structure units in the subset in the one functional region on the substrate are not completely same;
arrangement patterns of different sub-subsets of the nano-structure units in the subset in the one functional region on the substrate are not completely same;
orientations of the orthogonal projections of the nano-structure units in the subset in the one functional region on the substrate are not completely same; or
materials of the nano-structure units in the subset in the one functional region are not completely same.

5. The metasurface optical device according to claim 2, wherein shapes of the plurality of functional regions are not completely same.

6. The metasurface optical device according to claim 2, wherein areas of the plurality of functional regions are not completely same.

7. The metasurface optical device according to claim 2, wherein the plurality of functional regions are arranged in an array on the substrate.

8. The metasurface optical device according to claim 2, wherein the plurality of functional regions are sequentially arranged on the substrate along a circumferential direction of a circle.

9. The metasurface optical device according to claim 2, wherein the plurality of functional regions are nested and arranged sequentially on the substrate along a radial direction of a circle.

10. The metasurface optical device according to claim 1, wherein the plurality of nano-structure units are arranged on the substrate at a constant period.

11. The metasurface optical device according to claim 1, wherein the plurality of nano-structure units are arranged on the substrate at a varying period.

12. The metasurface optical device according to claim 1, wherein the plurality of nano-structure units include nanopillars or nanoholes.

13. The metasurface optical device according to claim 1, further comprising:
a reflective layer covering a surface of the substrate facing away from the nano-structure layer.

14. The metasurface optical device according to claim 1, further comprising:
a reflective layer covering a surface of the substrate facing toward the nano-structure layer.

15. An optical apparatus comprising:
a metasurface optical device including:
a substrate; and
a nano-structure layer disposed on the substrate, the nano-structure layer including a plurality of nano-structure units;
wherein the plurality of nano-structure units extend in a direction away from the substrate, and central axes of the plurality of nano-structure units form corresponding angles with respect to a normal direction of the substrate, such that the plurality of nano-structure units are arranged obliquely relative to the substrate.

16. The optical apparatus according to claim 15, wherein:
the nano-structure layer includes a plurality of functional regions;
each of the plurality of functional regions includes a corresponding subset of the plurality of nano-structure units; and
the plurality of nano-structure units are arranged in a manner that the plurality of functional regions have different optical functions.

17. The optical apparatus according to claim 16, wherein different ones of the plurality of functional regions are different in at least one of following aspects:
the angles between the central axes of the plurality of nano-structure units and the normal direction of the substrate;
shapes of orthogonal projections of the plurality of nano-structure units on the substrate;
dimensions of the orthogonal projections of the plurality of nano-structure units on the substrate;
dimensions of orthogonal projections of the plurality of nano-structure units on a direction perpendicular to the substrate;
arrangement periodicities of the plurality of nano-structure units on the substrate;
arrangement patterns of the plurality of nano-structure units on the substrate;
orientations of the orthogonal projections of the plurality of nano-structure units on the substrate; and
materials of the plurality of nano-structure units.

18. The optical apparatus according to claim 16, wherein one functional region among the plurality of functional regions satisfies at least one of:
the angles of the central axes of the nano-structure units in the subset in the one functional region relative to the normal direction of the substrate are not completely same;
shapes of orthogonal projections of the nano-structure units in the subset in the one functional region on the substrate are not completely same;
dimensions of the orthogonal projections of the nano-structure units in the subset in the one functional region on the substrate are not completely same;
dimensions of orthogonal projections of the nano-structure units in the subset in the one functional region on a direction perpendicular to the substrate are not completely same;
arrangement periodicities of the nano-structure units in the subset in the one functional region on the substrate are not completely same;
arrangement patterns of different sub-subsets of the nano-structure units in the subset in the one functional region on the substrate are not completely same;
orientations of the orthogonal projections of the nano-structure units in the subset in the one functional region on the substrate are not completely same; or
materials of the nano-structure units in the subset in the one functional region are not completely same.

19. The optical apparatus according to claim 16, wherein shapes of the plurality of functional regions are not completely same.

20. The optical apparatus according to claim 16, wherein areas of the plurality of functional regions are not completely same.
